(19) United States
(12) Patent Application Publication
(10) Pub. No.: US 2017/0265432 A1
(43) Pub. Date: Sep. 21, 2017

(54) METHODS AND SYSTEMS FOR PET LOCATION DETERMINATION AND TRAINING

(71) Applicants: Terry Anderton, Hampton Falls, NH (US); Samuel Stoddard, Somersworth, NH (US)

(72) Inventors: Terry Anderton, Hampton Falls, NH (US); Samuel Stoddard, Somersworth, NH (US)

(73) Assignee: WAGZ, Inc., Hampton Falls, NH (US)

(21) Appl. No.: 15/460,314

(22) Filed: Mar. 16, 2017

Related U.S. Application Data
(60) Provisional application No. 62/309,095, filed on Mar. 16, 2016.
(60) Provisional application No. 62/309,074, filed on Mar. 16, 2016.

(51) Int. Cl. A01K 15/02; G01S 19/14; G01S 11/02; A01K 27/00

(52) U.S. Cl. CPC A01K 15/023; A01K 15/029; A01K 27/009; A01K 27/001; A01K 27/006; G01S 19/14; G01S 11/026

(57) ABSTRACT

A pet training and location system including a collar configured to be affixed to a pet, the collar having a location determination mechanism; an audio transmitter configured to provide an audio stimulus; and a power source provided within collar operable to provide power to the audio transmitter, and the location determination mechanism. The system also includes a user platform configured to receive input from a user, the platform being operable to define at least one permitted zone where the pet is permitted to reside and at least one restricted zone where the pet is restricted from entering, wherein the collar is configured to provide at least one positive stimulus when the collar moves from the at least one restricted zone back into the at least one permitted zone.

### PRIORITY CLAIM

This application claims the benefit of U.S. provisional patent application Nos. 62/309,095 being filed on Mar. 16^{th,} 2016, and 62/309,074 also being filed on Mar. 16^{th ,} 2016, both of which are hereby incorporated by reference in their entirety.

### FIELD OF THE INVENTION

The present invention relates generally to pet collars, and particularly to pet collars having one or more sensors therein. Furthermore, the present invention relates to a system including a collar and non-collar items and the relational response or interaction between the collar with the secondary or non-collar items.

### BACKGROUND OF THE INVENTION

Pet collars have long been used to provide identification information regarding the home or owner location of pets, particularly when lost. Collars are also often used as an attachment means for leashes or other retention mechanisms for walking etc. Collars have also been used more recently as a vehicle for providing transceivers for global positioning and geolocation (GPS) usable for providing the real-time location of a pet, a particular use for when the pet is lost or otherwise wanders away from a specified area. These location mechanisms are then often used in the location of a pet when lost. However, collars have not yet been used as an effective training and data capturing mechanism for tracking pet activity and assisting in training, particularly passive training without real-time interaction with an owner.

### SUMMARY OF THE INVENTION

Contemplated herein is a pet training and location system which can be utilized by a pet owner to train a pet to behave in a certain manner and in particular location based training which trains the pet to remain in specified locations or within a particular distance from the owner. As such, the system as contemplated can include a collar configured to be affixed to a pet, the collar can have a location determination mechanism embedded therein which can provide a location of the pet. It will be appreciated that the collar can also provide additional sensors about the collar which can enable the collar to provide more information than merely a location which can include microphones, light, infrared, accelerometers, etc.

The system as contemplated can also include an audio transmitter, such as a speaker, which can be configured to provide an audio stimulus or provide an audio signal which can be either pleasing or unpleasant to the pet.

In order to provide the necessary power to each sensor, stimulus, or other auxiliary item a power source can be provided within collar operable to provide power to each of the aforementioned accessories, sensors, etc.

Also contemplated herein, is a user platform, such as an application, which can be configured to receive input from a user, the platform being operable to optionally define at least one permitted zone where the pet is permitted to reside and optionally at least one restricted zone where the pet is restricted from entering. It will be appreciated that such a platform can include overhead type maps, wherein perimeters or other enclosed areas can be defined and designated as permitted or restricted zones.

The collar can then be synchronized with the user platform wherein the permitted and restricted zones can work in conjunction with the collar to determine the designation of the present location and then react accordingly.

In some embodiments, the collar can then be configured to provide a negative stimulus to the pet when the collar is moved from a permitted zone to a restricted zone. Conversely, the collar can also be configured to provide a positive stimulus when the collar moves from a restricted zone back into a permitted zone.

In some embodiments, the user platform can be provided on a mobile device, the mobile device including an additional location determination mechanism. Accordingly, the user platform can be connected to a remote server having a processor configured to determine a distance between the mobile device and the collar, wherein the platform is configured to receive a user preference defining a moving permitted zone being within a threshold distance from the mobile device. It will be appreciated that the mobile device can also be provided with a local processor and perform the distance calculation locally on the mobile device, or even on the collar of the pet. In this manner, a permitted zone can be mobile, and move with respect to a user carrying the mobile device, or alternative location determination mechanism. In this manner, the system can be utilized as a wireless or tether-less leash system which requires the pet to stay within a certain prescribed distance from the user.

In some embodiments, the user platform can be configured to receive input from a user regarding a plurality of restricted zones, at least one restricted zone being encompassed by at least one permitted zone.

In yet additional embodiments, the positive stimulus can be provided as a positive audio stimulus provided through the audio transmitter. In some such embodiments, the positive audio stimulus can include a verbal recording of praise. However, additional audio stimuli are also contemplated herein which can be virtually any noise or signal which is pleasing to the pet. It will be appreciated that in some such embodiments, the audio transmitter can also be used to provide a negative stimulus by providing a sound which is displeasing to the pet.

In yet additional embodiments, the collar can be provided with an electrode wherein a negative stimulus can be provided as an electric shock provided through the electrode.

In yet additional embodiments, the audio transmitter can be configured to provide an audio warning when the collar enters a predetermined threshold distance from a restricted zone when in a permitted zone. Such a noise can be an innocuous beep, which the pet can learn to associate with a negative stimulus if a particular behavior, distance, or boundary is continued or disregarded.

In some additional embodiments, the system can include a processor being configured to interrupt the negative stimulus after a predetermined time threshold when the collar is in a restricted zone, and wherein the processor is configured to determine when a boundary between a permitted zone and a restricted zone is being approached from a restricted side to a permitted side, and from a permitted side to a restricted side, and wherein negative stimulus is only applied when moving from a permitted zone to a restricted zone.

Also, contemplated herein is a method of location based pet training, the method comprising the steps of providing a collar as discussed above, the collar having any one of the features, in any combination, in conjunction with a user platform configured to define one or more permitted zones and one or more restricted zones

The method can also include the steps of: receiving input on a user platform, the input including information regarding at least one permitted zone where the pet is permitted to reside and at least one restricted zone where the pet is restricted from entering in the collar reacts; providing a negative stimulus to the pet when the collar is moved from the at least one permitted zone to the at least one restricted zone; and providing a positive stimulus when the collar moves from the at least one restricted zone back into the at least one permitted zone.

In yet additional embodiments, the method can include the additional steps of: providing a mobile location determination mechanism about a user; and determining a distance between the mobile location determination mechanism and the collar, wherein the platform is configured to receive a user preference defining a moving permitted zone being within a threshold distance from the mobile location determination mechanism.

As discussed briefly above, the method can include a step of receiving user input regarding a plurality of restricted zones, at least one restricted zone being encompassed by at least one permitted zone.

In some embodiments, the method can include the step of determining when a boundary between a permitted zone and a restricted zone is being approached from a restricted side to a permitted side, and from a permitted side to a restricted side, as well as the step of applying only the positive stimulus when moving from a restricted zone to a permitted zone.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a front perspective view of an exemplary pet collar for use in a location based pet training system as contemplated herein;

FIG. 2 illustrates an exemplary schematic of a location based pet training system illustrative of various inventive concepts thereof;

FIG. 3 illustrates an exemplary schematic of a location based pet training system as used in a tether-less leash application;

FIGS. 4A-B illustrate top down locational views of various permitted and restricted zones and illustrating various use scenarios for training of a pet utilizing the location based pet training system as contemplated herein; and

FIG. 5 illustrates a top down locational view of various permitted and restricted zones and illustrating an alternative boundary determination means illustrating an alternative scenario for training of a pet utilizing a location based pet training system as contemplated herein.

### DETAILED DESCRIPTION OF THE INVENTION

Contemplated herein is a pet training and location system which can be utilized by a pet owner to train a pet to behave in a certain manner depending on the pet's particular location as determined by a collar being worn by the pet. In particular, the pet can be trained to stay in particular permitted areas and not enter restricted areas. In some instances the restricted and permitted areas can be statically located, such as in a yard, which is a permitted zone, as opposed to outside the yard, in a garden plot, or a flower bed, which can be defined as restricted zones. Or alternatively the permitted areas can be mobile, such as a certain distance from a user, like when walking with the pet, wherein the pet is only allowed to travel a certain maximum distance from the user.

In some instances, particularly when beginning training, it can be advantageous to provide negative stimulation, or negative reinforcement to discourage a pet from leaving the permitted zone and entering one or more restricted zones. However, in some instances, once a restricted zone has already been entered it can be important to cease providing negative reinforcement, and instead provide a positive stimulus or reinforcement to encourage the pet to return to the permitted zone. Additionally, in some instances, use of negative stimulus can be omitted altogether, and positive reinforcement used as the sole mechanism for location based training.

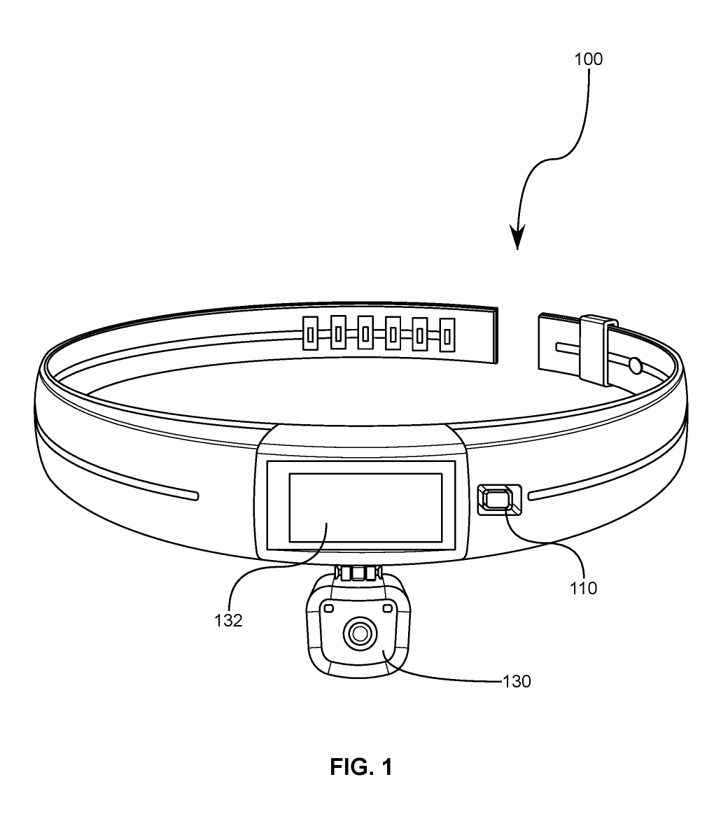

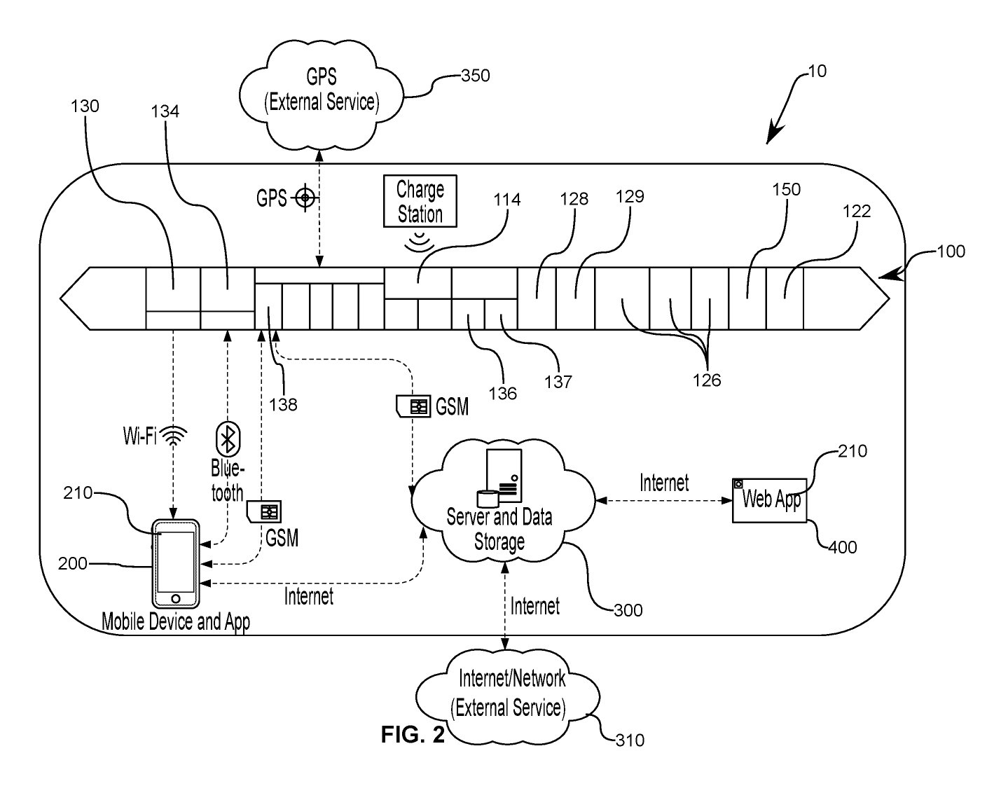

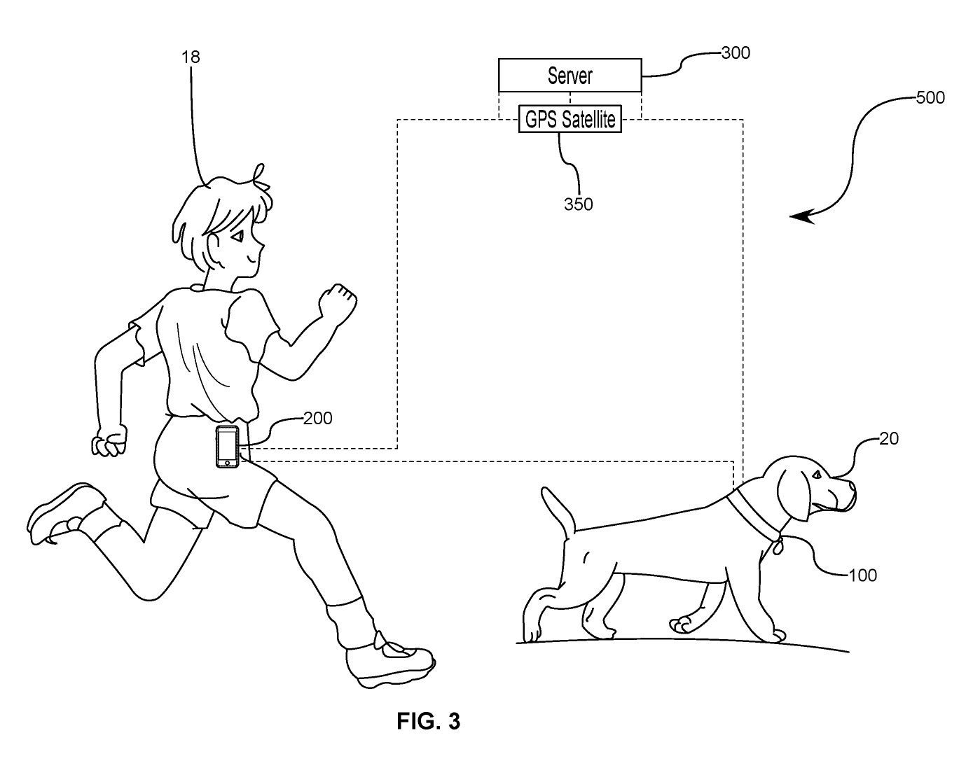

In accordance with these concepts, the system as contemplated can include a collar 100, as shown in FIGS. 1-2 which is configured to be affixed to a pet 20, the collar 100 can have a location determination mechanism 110 embedded therein which can provide a location of the pet 20. In some instances, the location determination mechanism can be a global positioning system (GPS) which can be utilized to provide a location of the pet within a certain degree of certainty using an external GPS location service 350. It will be appreciated that GPS is discussed herein in detail with the understanding that various location determination mechanisms can be utilized, including alternative sensors, triangulation methods, range finders, radio signals. Another particular example of setting up various permitted and restricted zones can include providing a wireless transmitter, such as a wi-fi transmitter, and wherein the permitted zone is defined as requiring the pet to stay within a distance of the transmitter to allow a particular signal strength, or maintain a wi-fi connection.

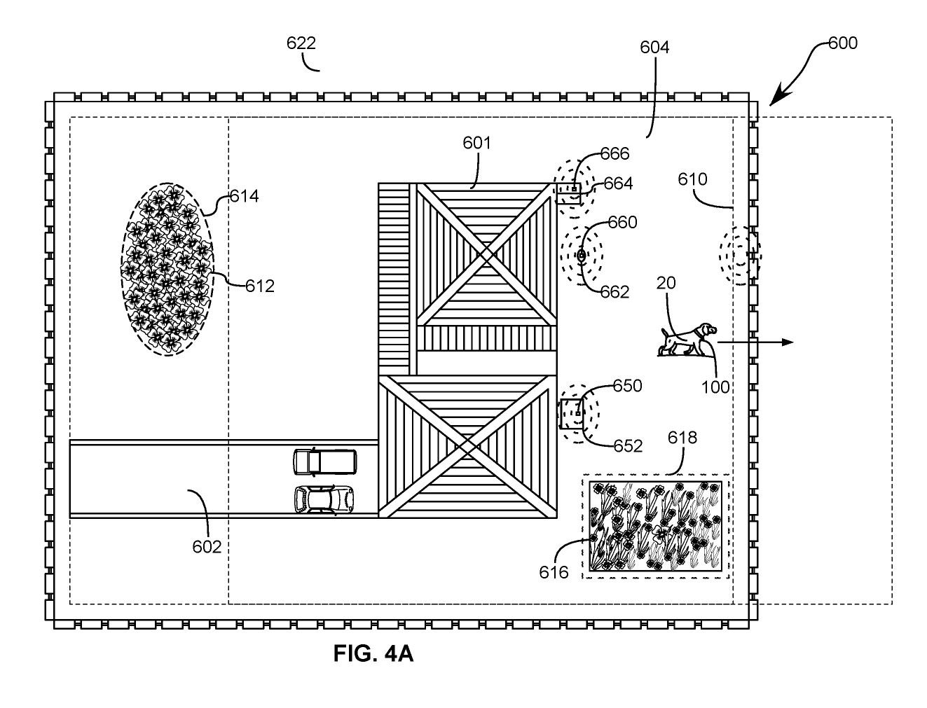

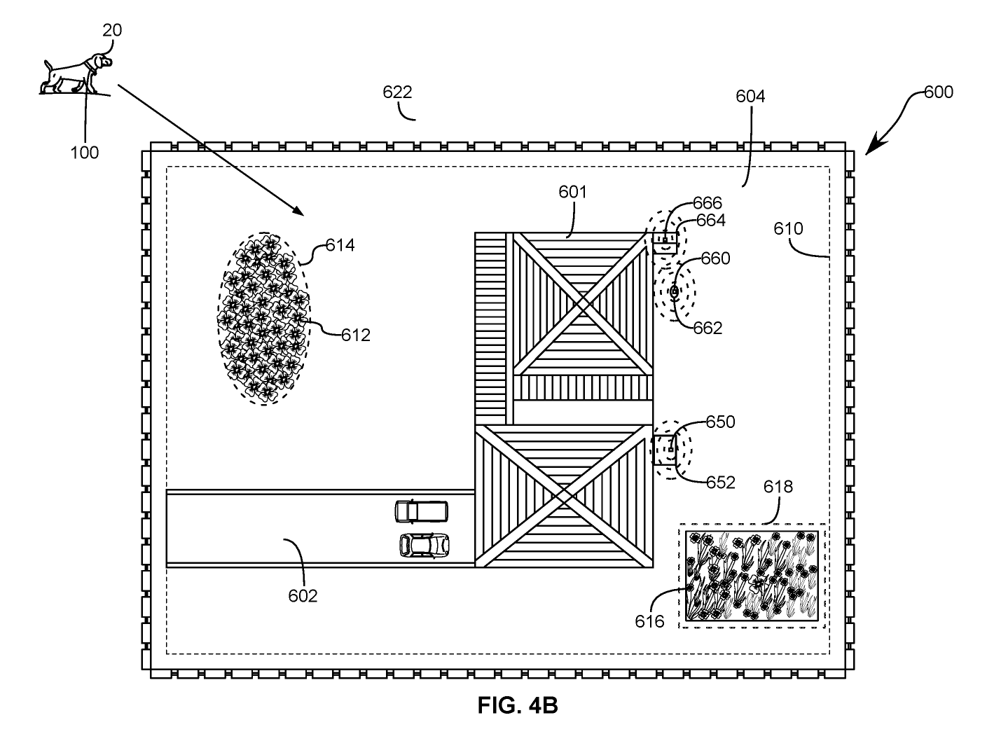

It will be appreciated that permitted zones can be defined using various methods, either within a connectable distance as discussed above, or alternatively the system 10 can be provided with a user portal 210 or web app which can present an interactive map to the user. It will also be understood that the user portal 210 can be presented to the user or interacted with by the user via an application on a mobile device 200 or using an online web portal 400. The interactive map can then be utilized by the user to draw boundary lines on the map and define interior or exterior portions of the boundaries as restricted or permitted zones. FIGS. 4A-B illustrate an overhead map view 600 with various defined boundary lines 610, 614, and 618 provided thereon. In this instance, the permitted zone can be listed as 604, which can coincide with a boundary of a piece of property around a house 601 and driveway 602 where the pet is allowed to stay and travel anywhere within this permitted zone 604. However, as illustrated the exterior portion of the boundary line 610 can be defined as a restricted zone 622, which indicates an area outside the yard. It will be appreciated that alternative restricted zones can include restricted zones which are actually inside or encompassed by the permitted zone. Some examples might include a restricted boundary 614 around a flower bed 612, or a restricted zone 618 around a garden plot 616. These restricted zones residing within a permitted zone are offered only for purposes of discussion and can encompass virtually any desired restricted area as determined by a user.

Also illustrated in FIGS. 2 and 4A-B is an alternative embodiment wherein the collar can also be provided with additional sensors about the collar which can enable the collar to provide more information than merely location, but interaction information with various alternative objects as well. In some instances, the additional sensors can include microphones, radio frequency identification (RFID) transmitters and sensors 150, proximity, light, infrared, accelerometers, etc.

By providing additional sensors 650, alternative activities can also be determined or controlled. In some instances, particularly for small restricted areas, 5 ft or less across, GPS, while accurate on a large scale, can be too inaccurate to define such a small restricted area. Some examples might include restricting the pet from chewing power lines or controls for an air conditioner 652, or power, cable, telephone lines. In some such instances a proximity sensor, such as RFID (passive or active), or near field communication (NFC) sensors and transmitters can be provided about such areas, wherein the proximity of the collar to a specified area can be detected, and a negative stimulus provided when such a proximity is detected.

It will be appreciated that providing negative stimulus, such as through an electrode 26, and associated electric shock has been utilized in many previously known systems and is known as a relatively effective training method. However, one aspect of the present invention involves providing not only a negative stimulus for a negative behavior, but also allows for providing a positive stimulus for corrective behavior or desired behavior. In particular, one aspect of the present invention involves providing a positive stimulus when a pet moves from a restricted zone to a permitted zone, or does something else that the user deems as a positive behavior. In order to provide positive stimulus, the system as contemplated can also include an audio transmitter 122, such as a speaker, which can be configured to provide an audio stimulus in the audible range or at ultrasonic frequencies which can be heard by the pet, but not the owner/user. In such cases, the audio transmitter 122 can be configured to provide an audio signal which can be either pleasing or unpleasant to the pet in response to determined behaviors. The audio transmitter 122 can provide positively trained sounds or recordings when positive activities are determined. For example, the user could record an audio recording of their voice offering praise to the pet, then the audio recording can be played to the pet when the pet comes back into the permitted zone from a restricted zone. Thus, secondary sensor 660 can be utilized to generate the positive reinforcement mechanisms associated with system 10 and collar 100. Whereas sensor 650 is utilized to trigger or generate the negative reinforcement mechanisms associated with system 10 and collar 100.

An example of this positive reinforcement process could involve a location detection that the pet is approaching a restricted boundary. As illustrated in FIG. 4A, the collar 100 can be configured to provide a warning to the pet, through a vibration or another audible signal. If the pet continues to move past the boundary, an electric shock can be applied to the pet in gradually increasing increments until it becomes clear that the shock is ineffective, i.e. for a predetermined time, or for a predetermined distance past the boundary. Such a noise can be an innocuous beep, which the pet can learn to associate with a negative stimulus if a particular behavior, distance, or boundary is continued or disregarded. However, when the pet approaches the boundary from a restricted side, as illustrated in FIG. 4B, the system 10, by means of the location mechanism 110, can determine that the pet is already in a restricted zone, and moving toward the boundary from that restricted side toward the permitted zone. In this instance the audio transmitter 122 can instead be configured to play an audible recording of praise for the pet.

It will then be appreciated that there exist explicitly defined permitted and restricted zones, however, there also exists the possibility that a particular zone is not explicitly defined and as such can be an undefined zone. It will then be appreciated that the negative stimulus can be applied on all of the following transitions: allowed zone to undefined zone, undefined zone to restricted zone, or allowed zone to restricted zone. Positive stimulus can then be applied on all of the following transitions: restricted zone to undefined zone, undefined zone to allowed zone, and restricted zone to allowed zone. It will further be appreciated that one or more user settings can be changed so as to automatically define all undefined zones as restricted zones, particularly when defining an enclosed permitted zone. As such, since there is at least one allowed zone, then all areas outside that allowed zone are, by definition, restricted, whether explicitly designated as such by the user or implicitly by default.

It will be understood that the audible signal can be configured to be any number of sounds, any of which can be trained to be a positive reinforcement sound for the pet. For example, with professional dog trainers the trainer can use a clicker which makes a particular noise, and give the dog a treat whenever they produce the sound with the clicker. Similar methods can be used in the present invention, and virtually any given sound with a predetermined or trained response from the pet can be utilized for this positive reinforcement. In some embodiments, such sounds can include chimes, or an ultrasonic version of any of the other sounds discussed above.

Further, it will also be understood that the audio transmitter can also be used for negative reinforcement, rather than using electric shock. In such cases the user can record a verbal reprimand, or some other negative reinforcement noise so as to provide a more humane negative reinforcement over the electric shock and electrode methodology.

In some embodiments, the RFID or NFC technology can also be used in alternative items, such as toys, beds, dog bowls, etc. to track the pet's activities and associate sounds and reinforcements with alternative training and behaviors. For example, in some instances the pet can be trained to enter a designated area in certain situations or in response to particular commands.

An example of this can be as follows: the user platform, as provided on a mobile device or a web portal can be configured to define multiple permitted zones and restricted zones. In some instances, the zones can be changed into various modes with varying configuration based on user input. For example, the user might know that the mailman comes between 3:00 PM and 4:00 PM every day, and as such, the user platform can be utilized to change the restricted zones and area based on a pre-determined schedule. So, in the case of the mailman, the permitted zone can extend to the property edges during the majority of the day, but from 2:30-4:30 the pet can be allowed only within a certain distance from an RFID sensor 666 located about the pet's shelter, i.e. dog house 664, located in an appropriate location in the back yard.

In some such embodiments, the system can be configured to provide an audible command through the audio transmitter, which could be a particular sound, or audio recording which warns the pet that modes are changing, and gives a particular pre-set time period in which the command must be obeyed. For example, the speaker could transmit a sound of the user giving the command “to bed”, and after thirty seconds the modes will change, and if the pet is not in the bed or dog house 664, it can get a warning vibration or beep, followed by a negative reinforcement. Conversely, if the pet obeys immediately, the collar can be configured to provide a positive reinforcement, such as a recording of “who's a good boy” when the command is obeyed upon a zone permission change, in which case a negative reinforcement was not needed, but a positive reinforcement would still be advantageous.

Similarly, a user can use positive reinforcement sounds or mechanisms in conjunction with an ‘action’ sound, such as a dinner bell, to train the animal to go to their feeding dish. Upon movement towards and/or arrival at the feeding dish the positive reinforcement sounds or mechanisms can be triggered. Furthermore, a combination of positive reinforcement for a first animal and negative stimulus for a second animal can be implemented where each animal has a collar. The user interface can trigger the “action” sound in the first animal's collar and use the positive reinforcement mechanisms as the first animal obeys. However, if the second animal tries to come toward the first animal's feeding dish, for example, a negative stimulus could be implemented to train the second dog that is either not their feeding time or that feeding dish is not their feeding dish. Thus, sensors 650 and 660 could be used interchangeably to trigger both positive and negative stimulus depending on which collar (associated with the first or second animal) is within the vicinity of the zone, toy, feeding dish, doghouse, etc.

In light of the above embodiments, it should be appreciated that zones or areas such as dog house 664 or feeding dish 662 can be configured to induce positive feedback, negative feedback, or no feedback based on the time of day or a particular setting that is automatically set or manually triggered by a user. As mentioned, some of these zones or areas might be too small for accurate GPS or Wi-Fi signals, thus having additional sensors 660 (or 650) attached to or near the designated zone, toy, dog house, feeding dish or bowl, and so forth can greatly enhance the facilitation of training certain behavior in the animal.

In some embodiments, the user platform can include a dedicated screen in the application being devoted to hands-on training. As desired, the user can press a positive button to cause the collar to issue the positive reinforcement signal to help with real-time association of a particular sound with positive reinforcement. As such a separate button on the same screen can then cause the collar to issue the negative reinforcement signal(s) for real-time association of a particular sound with negative reinforcement.

With this interface, a trainer can perform general training with the collar's reinforcement signals instead of, or in addition to, traditional reinforcement signals.

In this manner, if the user desires to teach a pet to use another object, i.e. a door, feeder, toy, bed, etc., then the positive reinforcement signal can be issued upon the pet interacting with that object. Interaction with the object can be detected, as discussed above, via RFID.

In this manner, such as when a dog is being trained in the field for police, fire, military, or rescue purposes, the positive reinforcement signal can be issued when the dog correctly reaches a desired objective, for example a dummy person to be rescued, or when an assailant is disarmed.

Alternatively, such as during agility training, the positive reinforcement signal can be issued when a dog correctly navigates each obstacle.

Further, when training a dog to identify drugs, bombs, or toxic substances, the positive reinforcement signal can be issued when the dog identifies the target object or substance.

It will also be understood that a power source 114, such as a battery, can be provided within collar which is configured to provide power to each of the aforementioned accessories, sensors, etc. The power source can be configured to be rechargeable either through a power port, or can incorporate wireless charging technology.

As discussed in some detail above, the system will include a user platform 210, such as an application, which can be configured to receive input from a user 18. It will be understood that the application/user platform can be accessed through mobile devices, web portals, or any number of suitable means. It will be understood that the platform is operable to define at least one permitted zone where the pet is permitted to reside and at least one restricted zone where the pet is restricted from entering. This can be achieved by defining or drawing boundaries, for example on a map.

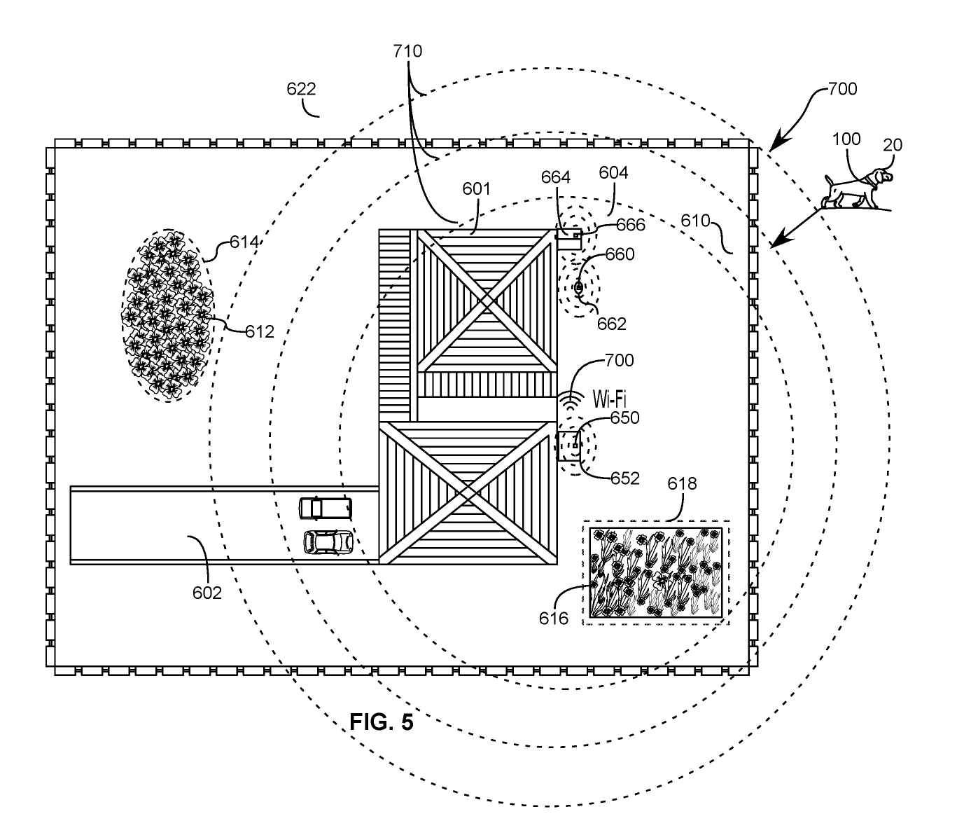

Alternatively, and as shown in FIG. 5, the boundaries could be defined as whether the collar is able to connect to a central transmitter such as a wi-fi router 700, etc. In some such instances, warnings can be generated based on signal strength thresholds 710 corresponding to various permitted distances from the wi-fi router 700, which can be correlated to relative proximity to the router. In some instances, this could be achieved using other radio transmitters etc.

It will also be understood that the aspects of the present invention with regard to positive reinforcement could also be implemented using physically buried boundary lines, or other physical electrical lines provided about the boundary.

Additionally, it will be understood that the collar can be provided with a local processing unit and non-transitory computer-readable media for tracking location or activities and saving data with regard to those activities locally. Such a local processor and non-transitory computer-readable media can store computer instructions wherein sounds, warnings, positive reinforcement, or negative reinforcement steps and when applied can each be determined locally and performed locally after transfer of such instructions from the user platform. Accordingly, the user platform can be connected to a remote server 300 having a remote processor and non-transitory computer-readable media can be utilized remotely, and instructions can then be transmitted to the collar to perform any such step or action using a mobile or home network.

In some embodiments, and as shown in FIG. 3. the system can be utilized as a tether-less or leash-less system 500. In this embodiment, a local or remote processor or non-transitory computer-readable media, which can be performed by a mobile device 200 or alternatively located on a remote server 300, can be configured to determine a distance between a mobile device having location determination mechanism, such as a GPS and the collar of the pet. It will be appreciated that the mobile device can be provided with a local processor which is configured to perform the distance calculation locally on the mobile device, or the processor could also be located on the collar of the pet 20. The user can then define a distance threshold to define a permitted zone within a certain distance of the user. In this manner, a permitted zone can be mobile, and move with respect to a user carrying the mobile device.

It will be appreciated that this location determination can be derived from GPS locators on the mobile device and the collar as discussed above, or can be RFID, Bluetooth, NFC, or radio connectivity or alternative location determination mechanism. In this manner, the system can be utilized as a wireless or tether-less leash system which requires the pet to stay within a certain prescribed distance from the user.

In some embodiments, as desired by the user, the positive reinforcement signal or audible signal can sound intermittently for the entire time that the dog remains within the specified range from the user to aid in training purposes. In this manner, when the pet is behaving well, and staying within the prescribed distance, the pet will get continuous positive reinforcement. Alternatively, the system can be configured to only offer the positive reinforcement when re-entering the prescribed threshold distance from an out-of-range situation.

In some additional embodiments, the system can include a processor being configured to interrupt the negative stimulus after a predetermined time threshold when the collar is in a restricted zone, and wherein the processor is configured to determine when a boundary between a permitted zone and a restricted zone is being approached from a restricted side to a permitted side, and from a permitted side to a restricted side, and wherein negative stimulus is only applied when moving from a permitted zone to a restricted zone.

Also contemplated herein is a method of location based pet training, the method comprising the steps of providing a collar as discussed above, the collar having any one of the features, in any combination, in conjunction with a user platform configured to define one or more permitted zones and one or more restricted zones.

The method can also include the steps of: receiving input on a user platform, the input including information regarding at least one permitted zone where the pet is permitted to reside and at least one restricted zone where the pet is restricted from entering in the collar reacts; providing a negative stimulus to the pet when the collar is moved from the at least one permitted zone to the at least one restricted zone; and providing a positive stimulus when the collar moves from the at least one restricted zone back into the at least one permitted zone.

In yet additional embodiments the method can include the additional steps of: providing a mobile location determination mechanism about a user; and determining a distance between the mobile location determination mechanism and the collar, wherein the platform is configured to receive a user preference defining a moving permitted zone being within a threshold distance from the mobile location determination mechanism.

As discussed briefly above, the method can include a step of receiving user input regarding a plurality of restricted zones, at least one restricted zone being encompassed by at least one permitted zone.

In some embodiments, the method can include the step of determining when a boundary between a permitted zone and a restricted zone is being approached from a restricted side to a permitted side, and from a permitted side to a restricted side, as well as the step of applying only the positive stimulus when moving from a restricted zone to a permitted zone. In yet additional embodiments negative stimulus can be applied on all of the following transitions: allowed zone to undefined zone, undefined zone to restricted zone, or allowed zone to restricted zone. Alternatively, or in addition to negative stimulus, positive stimulus can also be applied on all of the following transitions: restricted zone to undefined zone, undefined zone to allowed zone, and restricted zone to allowed zone. It will further be appreciated that one or more user settings can be changed so as to automatically define all undefined zones as restricted zones, particularly when defining an enclosed permitted zone. As such, since there is at least one allowed zone, then all areas outside that allowed zone are, by definition, restricted, whether explicitly designated as such by the user or implicitly by default.

Additionally, the collar system can include various sensors and interfaces including but not limited to a tangible display 132 providing pet identification information optical sensors, i.e. a cameras 130, a Global Positioning System (GPS) 110, RFID 150, infrared communication mechanisms, accelerometers, wi-fi adapters, Bluetooth adapters 134, SIM or GSM communication modules 138, temperature sensors, microphones, light sensors, ultrasonic, radio or virtually any other contemplated sensor which would be recognized by those having skill in the art as useful so as to provide a desired feedback regarding a pet activity, it will be appreciated that these various sensors are indicated by the single reference number 126, but can be provided as virtually any sensor which would provide information regarding a particular activity, parameter, or characteristic. Additionally, the collar can be provided with an interactive display 128 which can be used to access information or settings of the collar by a user. In some embodiments, the collar can also include lights 129 or other indicia which can aid in pet location when lost, particularly at night or other dark conditions. Such a light 129 can also be illuminated automatically in low-light conditions so as to aid in visibility, such as on walks for passing motorists, etc.

The system can also include processing capabilities and data storage capabilities which allow for activities to be determined, stored, and enter a desired mode based on a predetermined set of instructions in response to input or commands from the various sensor or commands provided through the communication systems. In some instances, pet data can be transmitted and stored over an external network or service 310 for data tracking of various pet activities, parameters, etc.

In various aspects of the present invention the various sensors can be divided into various primary groups and subset groups. In response to various sensor inputs the collar 100 can be prompted to enter into various modes wherein various primary and subset groups. For example, the GPS location sensor can detect that the pet, or at least the collar 100, has not moved in the last thirty minutes, in response to the sensor input the collar 100 can go into a sleep mode and turn off various sensors and only send out an intermittent location ping until movement is again detected, in this manner, power can be conserved by changing into various modes based on sensed data. In yet another example, the audio sensor or microphone in combination with an accelerometer can detect for example when a dog is barking, in response to a detected barking over a predetermined timeframe, in response the collar 100 can then activate the optical sensor or camera so as to detect or otherwise capture an image or video of what the dog is barking at. It is thus contemplated herein that various sensors can be primary sensors and can cause the collar 100 to enter various modes wherein various sensor subsets are activated or deactivated in response to sensor input. It will be appreciated that the collar system and application can have a predetermined mode set, and in some instances custom modes can be created or certain sensors can be manually controlled using the mobile application.

The mobile application, which can be specifically designed to connect to the collar 100 using Bluetooth technology on a smart device, can allow for control of the collar 100 itself in real-time. For example, an active mode or a user connected mode can allow the pet to leave a predetermined area without signaling alerts to a previously defined area perimeter.

In yet additional embodiments the collar 100 system can be connected to a control system or program during a charging process or other hard connection means when not being worn by the pet. Such connection and charging means can be provided using USB or other serial connections and charging methods.

It will be appreciated that other modes can be triggered using alternative methods, such as low power detection, wherein the device can enter a power saving mode and certain power draining sensors can be limited or otherwise. In such modes, power can be conserved by turning sensors such as the optical sensor, microphone, wi-fi and Bluetooth adapters off and only sending out the occasional location ping for purposes of pet location. It will be appreciated that in the event of a lost pet, that the most critical function is finding the pet, and other sensors for the purpose of tracking pet activity will become less important to an owner, meanwhile location functionality for the longest possible power duration will become most critical.

It will be appreciated that some sensors or communication adapters can be set into standby mode until the owner comes within range. In some embodiments, the power preservation mode can be automatically triggered when the pet wearing the collar 100 leaves a designated perimeter, or gets a certain distance from a set geolocation. In such an embodiment, the GPS locator can be considered a sensor primary and the other sensors on the collar 100 can be provided in a sensor subset in a turned off configuration. It will be further appreciated that circumstances can vary widely and that the control system, being provided on a mobile application for example, can be connected to the collar 100 and can override certain settings. For example, an owner may wish to take the pet somewhere for exercise, for example on a jog, and that the mobile application can tell the on-board collar 100 controls not to enter a lost and power conserving location mode when the owner and the pet leave a designated perimeter. It some instances a switch can be provided or a specific mode can be manually selected using a display or other user interface on the collar 100 itself so as to allow for different control and subset modes based on specific situations. For example a traveling mode could be selected wherein a specific sensor subset configuration can be set up and created by the user/owner for a specific desired activity.

In some embodiments, the collar 100 can be configured to automatically enter certain modes and configurations based on additional sensor input. For example, if the location sensors determine that the collar 100/pet is traveling at a speed which is faster than the pet can travel unassisted, it can be reasonably assumed that the pet is not lost, but is rather in or on an owner/user operated vehicle. Or alternatively, if the pet is outside a designated area but remains connected via Bluetooth to the user's mobile application on a smart device, that the pet is not lost but is with the owner, and as such certain sensors will remain active while the pet and owner are together and away from home and can track the activities even though a default function would be to enter a power saving mode.

In some embodiments, the collar 100 can be configured to connect periodically using alternative connection means such as using a GSM or SIM to a mobile network and can cause alerts to be delivered to the user/owner under certain circumstances. In this exemplary embodiment an alert can be generated and delivered to the owner/user's smart device that the pet has left the property, and can ask the user/owner for a response input. For example, the pet has left the yard, is the movement authorized or is the pet lost. In response to the notification, the user/owner can then select and send a command whether the collar 100 should enter power saving location mode or whether the collar 100 should enter an alternative supervised mode which will keep certain alternative sensor subsets active based on the owner authorized activity.

In some embodiments, the collar 100 can be set into various primary modes such as, at home, or roaming/traveling, away from home, etc., which modes can control various sensor subsets to behave in customizable or predetermined ways. For example, in a roaming or walking mode, the GPS can become more active and track the distance traveled and a distance calculation can be performed between the location of the collar 100 and the location of a mobile smart device such as a smartphone indicating the location of a user/owner. A predetermined distance allowance can then be calculated and the pet can be permitted to operate or run within the zone and the collar 100 will remain in the specified walking mode so as to operate as a wireless leash.

In yet another alternative embodiment, a Bluetooth connection can be utilized so as to constitute the mobile leash and a loss of connection, caused by the collar 100 traveling beyond a Bluetooth connectivity distance will cause the collar 100 to give positive or negative reinforcement, as well as send a notification to the user/owner smart device.

It will be appreciated that a speaker can be provided wherein the user/owner can give verbal commands, positive reinforcement or otherwise. In other embodiments, negative reinforcement mechanisms such as vibrators 136 or shock electrodes 137 can be provided so as to provide negative reinforcement for certain behaviors. Each of these functions can be automatically activated or alternatively manually activated via the mobile smart device of the owner/user using the control application.

In yet additional embodiments the sensors in the pet collar 100 can be utilized to interact with detectable secondary items, said secondary items can have active or passive sensors embedded within the secondary items. In yet additional embodiments the pet collar 100 can have active transmitters, communication devices, or sensors which are capable of interacting with alternative receivers, transmitters, communication devices, or sensors provided in alternative items separate from the control application provided on a computer or smart device configured to control the collar 100.

For example, a pet toy manufacturer can embed a sensor in a toy and can track pet interest trends in certain toys with respect to other toys. In yet additional embodiments a pet food manufacturer can embed a sensor in a feeding dish, wherein proximity to the feeding dish can cause the camera or other sensors capable of detecting which kinds of food are being provided to the pet, and a small video recording can show the pets interest therein. In yet additional examples, a toy having corresponding sensors embedded therein can be caused to react to the pet's proximity by recognizing proximity and then vibrating or emitting a noise or other stimulus in order to attract the pet's attention.

In yet additional embodiments secondary items such as toys can be detected as discussed above, and the detection can cause a stimulus to be activated in the collar. For example, a secondary item such as a designer toy with an embedded sensor can cause a speaker on the collar to provide positive feedback when the pet plays with the toy. In other instances sensors could be placed strategically within a home for example and proximity thereto can trigger a negative stimulus such as a vibration or electric shock so as to deter the pet from performing or doing an undesired behavior, such as for example laying on the owner's furniture or drinking from the toilet. This being achieved by placing a negative reinforcement sensor in or on the furniture cushions or sticking a sensor to the side of the toilet.

In certain embodiments, the control application can be utilized to customize a collar response by registering each of the individual independent proximity sensors and saving a profile therefore which prompts specific stimuli based on the proximity thereto. For example, a sensor on a cat and a sensor on a dog can prompt a negative response to discourage the dog from chasing the cat.

In yet additional embodiments certain collar responses can be customized by a user using the control application, such as a custom recording including particular and customized praise(s)/reprimand(s) to be played back by the speaker based on a sensed proximity to a particular item or boundary.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed:

1. A pet training and location system, the system comprising:
a collar configured to be affixed to a pet, the collar further comprising:
a location determination mechanism;
an audio transmitter configured to provide an audio stimulus; and
a power source provided within collar operable to provide power to the audio transmitter, and the location determination mechanism; and
a user platform configured to receive input from a user, the platform being operable to define at least one permitted zone where the pet is permitted to reside and at least one restricted zone where the pet is restricted from entering, wherein the collar is configured to provide at least one positive stimulus when the collar moves from the at least one restricted zone back into the at least one permitted zone.

2. The pet training and location system of claim 1, wherein the user platform is provided on a mobile device, the mobile device including a location determination mechanism.

3. The pet training and location system of claim 2, further comprising:
a remote server having a processor configured to determine a distance between the mobile device and the collar, wherein the platform is configured to receive a user preference defining a moving permitted zone being within a threshold distance from the mobile device.

4. The pet training and location system of claim 1, wherein the user platform is configured to receive input from a user regarding a plurality of restricted zones, at least one restricted zone being encompassed by at least one permitted zone.

5. The pet training and location system of claim 1, wherein the positive stimulus is provided as a positive audio stimulus provided through the audio transmitter.

6. The pet training and location system of claim 5, wherein the positive audio stimulus includes a verbal recording of praise.

7. The pet training and location system of claim 1, wherein the collar is configured to provide at least one negative stimulus to the pet when the collar is moved from the at least one permitted zone to the at least one restricted zone, and wherein the collar is provided with an electrode and wherein the negative stimulus is provided as an electric shock provided through the electrode.

8. The pet training and location system of claim 7, wherein the audio transmitter is configured to provide an audio warning when the collar enters a predetermined threshold distance from a restricted zone when in a permitted zone.

9. The pet training and location system of claim 7, wherein the system further comprises a processor being configured to interrupt the negative stimulus after a predetermined time threshold when the collar is in a restricted zone, and wherein the processor is configured to determine when a boundary between a permitted zone and a restricted zone is being approached from a restricted side to a permitted side, and from a permitted side to a restricted side, and wherein negative stimulus is only applied when moving from a permitted zone to a restricted zone.

10. A method of providing location based pet training, the method comprising the steps of:
providing a collar to a pet, the collar comprising:
a location determination mechanism;
an audio transmitter configured to provide an audio stimulus; and
a power source provided within collar operable to provide power to the audio transmitter, and the location determination mechanism;
receiving input on a user platform, the input including information regarding at least one permitted zone where the pet is permitted to reside and at least one restricted zone where the pet is restricted from entering in the collar reacts; and
providing a positive stimulus when the collar moves from the at least one restricted zone back into the at least one permitted zone.

11. The method of claim 10, further comprising:
providing a mobile location determination mechanism about a user; and
determining a distance between the mobile location determination mechanism and the collar, wherein the platform is configured to receive a user preference defining a moving permitted zone being within a threshold distance from the mobile location determination mechanism.

12. The method of claim 10, further comprising:
receiving user input regarding a plurality of restricted zones, at least one restricted zone being encompassed by at least one permitted zone.

13. The method of claim 10, wherein the positive stimulus is provided as a positive audio stimulus being associated with a previous positive event, the positive stimulus being provided through the audio transmitter.

14. The method of claim 13, wherein the positive audio stimulus includes a verbal recording of praise.

15. The method of claim 10, further comprising: providing at least one negative stimulus to the pet when the collar is moved from the at least one permitted zone to the at least one restricted zone; and

16. The method of claim 15, wherein the collar is provided with an electrode and wherein the negative stimulus is provided as an electric shock provided through the electrode.

17. The method of claim 15, further comprising:
providing an audio warning when the collar enters a predetermined threshold distance from a restricted zone when in a permitted zone.

18. The method of claim 15, further comprising:
interrupting the negative stimulus after a predetermined time threshold when the collar is in a restricted zone.

19. The method of claim 15, further comprising:
determining when a boundary between a permitted zone and a restricted zone is being approached from a restricted side to a permitted side, and from a permitted side to a restricted side; and
applying only the positive stimulus when moving from a restricted zone to a permitted zone.

20. A pet training and location system, the system comprising:
a collar configured to be affixed to a pet, the collar further comprising:
a location determination mechanism;
an audio transmitter configured to provide an audio stimulus;
an electrode; and
a power source provided within collar operable to provide power to the audio transmitter, and the location determination mechanism; and
a user platform configured to receive input from a user, the platform being operable to define at least one permitted zone where the pet is permitted to reside and at least one restricted zone where the pet is restricted from entering, wherein the collar is configured to provide at least one negative stimulus when the collar is moved from the at least one permitted zone to the at least one restricted zone and wherein the collar is configured to provide at least one positive stimulus when the collar moves from the at least one restricted zone back into the at least one permitted zone;
wherein the positive stimulus is provided as a positive audio stimulus provided through the audio transmitter;
wherein the positive audio stimulus includes a verbal recording of praise.

21. The pet training and location system of claim 1, further comprising:
a mobile location determination mechanism being configured to be attached to the user; and
a remote server having a processor configured to determine a distance between the mobile location determination mechanism and the collar, wherein the platform is configured to receive a user preference defining a moving permitted zone being within a threshold distance from the mobile location determination mechanism.
